(19) United States
(12) Patent Application Publication
(10) Pub. No.: US 2022/0167582 A1
(43) Pub. Date: Jun. 2, 2022

(54) APPARATUS FOR MILKING ANIMALS, IN PARTICULAR COWS

(71) Applicant: LEMMER FULLWOOD GMBH, Lohmar (DE)

(72) Inventor: Jan-Eric LEMMER, Herford (DE)

(21) Appl. No.: 17/430,641

(22) PCT Filed: Feb. 14, 2020
(86) PCT No.: PCT/EP2020/053949

§ 371 Date: Aug. 12, 2021

(30) Foreign Application Priority Data
Feb. 15, 2019 (EP) 19157467.2

(51) Int. Cl. A01J 5/08

(52) U.S. Cl. CPC A01J 5/08

(57) ABSTRACT

The device for milking animals, in particular cows, is provided with a teat cup (10, 10A, 10C, 10D) having an outer sleeve (12) and an elastic teat-receiving tube (30). The teat-receiving tube (30) abuts the ends (14, 16) of the outer sleeve (12) in an air-tight manner. The teat-receiving tube (30) is surrounded by an annular space (46) which is divided in axial extension into at least two or three annular chambers (48, 50) which are separated from each other in an air-tight manner by a partition wall (52). Each annular chamber (48, 50) is in fluid communication with a pneumatic line via which the respective annular chamber (48, 50) can be selectively and independently of the respective adjacent annular chamber (48, 50) subjected to negative and/or positive pressure and atmospheric pressure in accordance with a predeterminable time-dependent pulsation pattern.

The invention relates to an apparatus for milking animals, in particular cows. The invention particularly relates to a teat cup for a milking equipment or for a milking robot, wherein the teat cup comprises an annular space (so-called pulsation space) divided in axial direction between its outer sleeve and the elastic teat-receiving tube (so-called liner). The invention is not limited to the application for milking of cows but can also be applied to other milk-providing animals, e.g. sheep, goats, lamas, camels, dromedaries, buffalos, yaks and reindeers.

An apparatus for particularly automatic milking of animals comprises as one of its components a teat cup which is provided with a rigid outer sleeve and an elastic teat-receiving tube being arranged within said outer sleeve. The teat-receiving tube is in sealing contact with the open ends of the outer sleeve and has a teat-receiving end and a connection end opposite to it, which projects beyond the outer sleeve and is in fluid communication with a milk discharge system. Inside the outer sleeve, an annular space is formed between the inner side of the outer sleeve and the teat-receiving tube, which is also called pulsation space. Typically, during the milking process, a negative pressure is present at the connection end of the teat-receiving tube, while the pulsation or annular space is alternately pressurized with atmospheric pressure or, in particular, with the same negative pressure as the inside of the teat-receiving tube, resulting in alternating contractions and relaxations of the teat-receiving tube, so that the milk is pressed out of or sucked out of the cistern of the teat through its teat canal.

In U.S. Pat. Nos. 3,659,558, 6,427,624B, 6,435,132B and BE-A-356 821 teat cups of the aforementioned type are disclosed.

A milking system and a method for operating the same are know from WO-A-2005/000011.

DE-A-2 331 123 describes a teat cup in which the teat-receiving tube comprises a plurality of longitudinally spaced annular bellows which, by appropriate sequential pneumatic control, exert a longitudinally progressive contraction on teat-receiving tube and thus massage the teat in a manner similar to milking by hand. Something similar is also described in EP-B-1 647 183. However, in both of the previously described designs of a teat cup, it is of certain disadvantage that the teat-receiving tube can only be replaced with relatively great effort. In the case of the two known concepts, it would therefore be more likely to replace the entire teat cup, which is comparatively cost-intensive.

FR-A-2 413 850 describes a teat cup whose annular space between the teat-receiving tube and the outer sleeve is divided axially into two chambers. The partition wall protrudes from the teat-receiving tube as a kind of annular flange or skirt and is enclosed at its thickened peripheral edge region by a circumferential encompassing projection protruding from the inner side of the outer sleeve. The assembly of this teat-receiving tube in the outer sleeve of the teat cup requires a two-part design of the outer sleeve, which is separated at the level of the encompassing projection.

An object of the invention is to provide a device for milking animals, in particular cows, comprising a teat cup whose teat-receiving tube can be subjected to progressive contraction in longitudinal direction and can be replaced in a comparatively simple manner.

This object is achieved with the invention proposing a device for milking animals, in particular cows, which is provided with
at least one teat cup having a rigid outer sleeve and an elastic teat-receiving tube being arranged in the outer sleeve,
wherein the outer sleeve comprises an open first end and an open second end opposite thereto,
wherein the teat-receiving tube has a teat-receiving end abutting the first end of said outer sleeve in an air-tight manner and a connection end projecting beyond the second end of the outer sleeve for connection to a milk discharge system and abutting the second end of the outer sleeve in an air-tight manner,
wherein the teat-receiving tube is surrounded by an annular space and extends under axial tension within the outer sleeve between the two ends thereof,
wherein the annular space is divided in axial extension into two or three annular chambers which are separated from each other in an air-tight manner by partition walls,
wherein each annular chamber is in fluid communication with a pneumatic line via which the respective annular chamber can be selectively and independently of the respective adjacent annular chamber subjected to negative and/or positive pressure and atmospheric pressure in accordance with a predeterminable time-dependent pulsation pattern, and
a pneumatic control unit for exerting a negative pressure in the teat-receiving tube with simultaneous cyclic pressurization of the annular chambers by alternately applying negative and/or positive pressure and atmospheric pressure in accordance with a predeterminable time-dependent pulsation pattern,
wherein the at least one partition wall is formed as an elastomeric annular membrane extending from the teat-receiving tube and having an outer circumferential region facing away from the teat-receiving tube, with which the annular membrane abuts in its outer circumferential region against the inside of the outer sleeve and is held sealingly against the inner side of the outer sleeve by a retaining ring which is tightly surrounded radially outwardly by the outer circumferential region of the annular membrane,
wherein the retaining ring is formed as a radially outwardly biased spring ring, the diameter of which can be reduced by generating an outwardly directed biasing force, and
wherein a circumferential receiving groove is formed on the inner side of the outer sleeve for receiving the spring ring in its region enclosed by the outer circumferential region of the annular membrane.

The device according to the invention comprises at least one teat cup having a rigid outer sleeve and an elastic teat-receiving tube being arranged in said outer sleeve. The outer sleeve is open at each of its two front ends. At the upper first end of the outer sleeve is the teat-receiving end of the teat-receiving tube, which is arranged in an air-tight manner at the first end of the outer sleeve. The teat-receiving tube is located under axial tension in the outer sleeve and is also arranged to terminate in an air-tight manner at its second end. The teat-receiving tube extends beyond the second end of the outer sleeve and has a connection end that is in fluid communication with the milk discharge system, which is typically under negative pressure during the milking process.

According to the invention, the annular space (also referred to as pulsation space), which is free over 360 degrees, between the teat-receiving tube and the inner side of the outer sleeve is divided axially into at least two or three annular chambers. Adjacent annular chambers are separated from each other in an air-tight manner by partition walls.

Each annular chamber is in turn uninterruptedly free over 360 degrees in circumferential direction. The partition walls between adjacent annular chambers form the only additional connection of the teat-receiving tube to the outer sleeve (and this in addition to the air-tight closure of the ends of the outer sleeve by the teat-receiving tube). The adjacent ring chambers are now subjected to negative or positive pressure and/or atmospheric pressure according to a pulsation pattern. The pulsation pattern applied per annular chamber is now cyclically applied to the adjacent annular chambers so that there is a “traveling” contraction of the teat-receiving tube in the longitudinal direction of the teat-receiving tube.

Tests have shown that the division of the annular space in axial extension into two annular chambers is sufficient, with the partition wall being arranged approximately at the level of the lower end section of the cistern of the teat facing the teat canal, relative to a teat of average length.

If the upper annular chamber is now contracted during milking, the milk in the cistern of the teat is pressed out towards the teat canal. Subsequent additional contraction of the lower annular chamber (possibly with simultaneous or time-delayed relief of the teat-receiving tube in the upper annular chamber) now pushes this milk further in the direction of the teat canal and out of it, or sucks it out (due to the negative pressure typically present permanently at the connection end of the teat-receiving tube during the milking process).

The essential feature of the invention is the sealing cooperation of the partition wall protruding from the teat-receiving tube with the outer sleeve of the teat cup for the division into (respectively) two axially adjacent (pulsation) annular chambers in the teat cup.

According to the invention, it is provided that the at least one partition wall is designed as an elastomeric annular membrane extending outwardly from the teat-receiving tube and having an outer circumferential region facing away from the teat-receiving tube. The advantage of this variant is that the partition wall is now also elastic in the radial direction, which is advantageous for the alternating or sequential contraction and relaxation, with overlap intervals, of the teat-receiving tube within its sections associated with the annular chambers.

According to the invention, it is further provided that the annular membrane abuts the inner side of the outer sleeve in its outer circumferential region and is held pressed against the inner side of the outer sleeve in an air-tight manner by a support or retaining ring. In this embodiment of the invention, the annular membrane is stabilized by a circumferential support ring. If such a teat-receiving tube is now pulled out of the upper first end of the outer sleeve of the teat cup in order to insert a new teat-receiving tube, the support ring slides along the inside of the outer sleeve with the outer circumferential region of the annular membrane resting against the inner side of the outer sleeve. Correspondingly, the support ring with the external outer circumferential region of the annular membrane of the new replaced teat-receiving tube also moves back along the inside of the outer sleeve when this new teat-receiving tube is inserted into the teat cup.

According to the invention, the support or retaining ring is designed as a spring ring which can be pretensioned radially outwards and which, as in the case of a snap ring, can apply a pretensioning force acting radially outwards, by means of which the outer circumferential region of the annular membrane is pressed with sufficient retaining force and sealingly into a circumferential receiving groove on the inner side of the outer sleeve, in which the spring ring then also engages according to the invention. The outer circumferential region of the annular membrane sealingly surrounds the radially external spherical (or cylindrical) circumferential surface of the spring ring.

The main advantage of the device according to the invention is therefore the simple design of the teat cup and teat-receiving tube, which makes it easy to replace the teat-receiving tube. The teat-receiving tube must be replaced after a predetermined number of milking procedures for reasons of hygiene. It is advantageous in this respect that the teat-receiving tube does not require any structurally complex connection/mounting to the teat cup, in particular that it is arranged in the teat cup without transverse tension to the teat cup. The teat-receiving tube is inserted into the outer sleeve in the usual manner via the first end of the outer sleeve, with the teat-receiving tube being slipped over the receiving sleeve with its teat-receiving end at the first opening of the receiving sleeve. The lower end of the teat-receiving tube then protrudes over the second opening of the outer sleeve. If this end of the teat-receiving tube is now pulled, the support or retaining ring with an annular membrane firmly attached thereto slides along the inner side of the receiving sleeve, being radially compressed in this phase. As the support or retaining ring slides further along, it finally enters the receiving groove and engages there. By further pulling on the teat-receiving tube, the support or retaining ring is then fixed under tension at the lower second end of the receiving sleeve, as is basically known. This is also typically achieved by latching the teat-receiving tube to the opening edge at the second lower end of the outer sleeve.

By dividing the pulsation chamber into at least two or at least three annular chambers following one another in the axial direction, the massage effect on the teat and the closing function of the teat-receiving tube are optimized. When using the device according to the invention, it is possible to carry out the process of machine milking more efficiently with conventional milking equipment or with a milking robot, taking into account the anatomy and the teats and physiology. Due to the faster milk release, the teats are less stressed without the stress per unit of time itself being greater than is the case with conventional teat cups. The gentle treatment of the teats during milking improves and ensures the health of the udder. In a further expedient embodiment of the invention, it may be provided that the outer sleeve is either cylindrical or conical. The conicity is such that the advantageously one-piece outer sleeve has at least one axial region in which it tapers conically towards its second end. The receiving groove is located in this partial region or in the transition of this partial region to a subsequent possibly cylindrical region of the outer sleeve. This conically tapering partial region of the outer sleeve thus acts as an inlet area or insertion area of the support or retaining ring for gradual radial compression until the support ring, which is designed as a spring ring, then engages with slight radial relaxation in the receiving groove, in which the support ring is fixed in a latching manner with the interposition of the outer circumferential region of the ring groove between the support ring and the receiving groove.

The spring ring provided according to the invention can be designed as a planar ring or as a partial helix ring. The spring ring is slotted and, in this respect, has two ends facing each other. These ends can be spaced apart from one another or can adjoin each other. In the tensioned state, in which the spring ring is seated in the receiving groove, this distance is minimal. In the case of overlapping ends of the spring ring, there is no distance to the outside; the spring ring is closed to the outside in this respect. The two overlapping ends of the spring ring can be radially or axially adjacent to each other or radially or axially offset from each other. All these designs enable the spring ring to have a substantially closed contour on its spherical or geometrically different outer side, which can also be cylindrical.

For the concept of the device according to the invention, as described above, the outer sleeve can be formed in one part or in several parts. In particular, it is advantageous that a multi-part design of the outer sleeve is not absolutely necessary. Also, if the annular space between the teat-receiving tube and the outer sleeve of the teat cup is to be divided into more than two axial annular chambers, for example into three annular chambers, each partition wall between two adjacent annular chambers can be designed as described above. In the case of a conical design of the outer sleeve, the respective spring rings would therefore be located in axially offset receiving grooves and consequently also have different diameters.

In a further embodiment of the invention, as an alternative to the variant described above, the outer sleeve has a number of axially successive outer sleeve sections equal to the number of ring membranes, the outer circumferential region of the at least one ring membrane or of each ring membrane being arranged in an air-tight manner between the mutually facing ends of adjacent outer sleeve sections. Adjacent outer sleeve sections are joined together in an air-tight manner with the outer circumferential regions of the respective membranes interposed. This can be done by plug, screw, bayonet or flange connections. In the latter case, the outer sleeve sections have annular flanges at their opposite ends, between which the outer circumferential region of an annular membrane is arranged. To replace a teat-receiving tube, the outer sleeve must be separated in sections and later reassembled in sections.

Thus, in the previously described exemplary embodiment of the invention, it can be provided that two adjacent outer sleeve sections can be screwed together in an air-tight releasable manner and/or can be connected to each other in a releasable manner by individual connecting elements, such as screws or screws with screw nuts or by a bayonet lock and/or can be inserted into each other in an air-tight releasable manner.

The teat-receiving tube is made of an elastomeric material such as rubber. The one or more annular membranes are either integrally formed with the teat-receiving tube or are fabricated as an element separate from the teat-receiving tube and subsequently bonded (e.g., vulcanized) to the teat-receiving tube in an air-tight manner. Each annular membrane can be formed as a kind of annular flange of an elastomer sleeve or elastomer tube, which is slid onto the teat-receiving tube and then bonded to it in an air-tight manner at the desired height or position.

As an alternative to the configuration of the at least one partition wall of the teat cup as an elastomeric annular membrane projecting from the teat-receiving tube, it can be provided according to a variant of the invention that the at least one partition wall is designed as an inner flange projecting from the inner side of the outer sleeve into the annular space and having an inner circumferential edge, and that the teat-receiving tube is provided with at least one outer circumferential groove, in which the inner circumferential edge of the inner flange is received in an air-tight manner, or is provided with at least one outer circumferential rib which is received in an air-tight manner in a groove on the inner circumferential edge of the inner flange. In this variant, inner flange protrusions protrude into the interior of the outer sleeve from the inner side of the outer sleeve. The inner circumferential edge of each such inner flange is connected in an air-tight manner to the teat-receiving tube, which can be done, for example, by means of an outer circumferential groove on the teat-receiving tube, into which the inner circumferential edge of the inner flange is immersed in an air-tight manner. In this area of the teat-receiving tube, the latter can have an outer thickening (outer bead) with a circumferential outer circumferential groove. However, the concept can also be applied in an inverted manner. In this case, the inner circumferential edge of the inner flange is provided with a receiving groove which is open towards the teat-receiving tube, which in turn has an outer circumferential rib which is immersed in the receiving groove of the inner circumferential edge of the inner flange and is thus received in an air-tight manner.

The aforementioned configuration of the outer sleeve has the advantage that the teat-receiving tube can now be replaced and inserted in a similar way as is the case today with conventional teat cups. For insertion, the teat-receiving tube is inserted over the first upper end of the outer sleeve. After the teat-receiving end has been placed in an air-tight manner on the upper end of the outer sleeve, the connection end of the teat-receiving tube protruding from the lower end of the outer sleeve is pulled axially until the inner circumferential flange is engaged in an air-tight manner with the teat-receiving tube. In this situation, the section of the teat-receiving tube extending through the upper annular chamber is now under axial tension. If the connection end of the teat-receiving tube is then pulled further, the teat-receiving tube engages with its typically present further circumferential outer groove with the lower end of the outer sleeve in an air-tight manner, so that the axial section of the teat-receiving tube associated with the lower annular channel is now also under axial tension. If the annular or pulsation space around the teat-receiving tube were to be divided into three successive annular chambers, the process described above would be run through a further time, so that finally the teat-receiving tube would then be arranged in an air-tight manner in the outer sleeve at the upper end, i.e. at the teat-receiving end, at the lower end of the outer sleeve and at the two inner circumferential flanges in the outer sleeve.

Due to the contraction of the teat-receiving tube, the tongue-and-groove joint of the teat-receiving tube with the respective inner circumferential flange (partition wall) is subjected to tensile stresses. In order to further secure these tensile stresses against unintentional detachment of the air-tight connection, it can be provided in a further embodiment of the invention that at least one retaining projection and preferably several retaining projections arranged distributed along the inner circumferential edge of the inner flange protrude in axial extension of the outer sleeve, wherein the projection or projections, in order to ensure the air-tight contact of the teat-receiving tube with the inner circumferential edge of the inner flange, engages or engage with the teat-receiving tube in the event of contraction of the teat-receiving tube. The at least one retaining projection may be formed as an annular projection, that is, a circumferential projection. It is expedient if each retaining projection has a sawtooth profile, with the steep flank of the retaining projection facing the inner side of the outer sleeve. The retaining projection or projections may also be formed as individual elevations extending along a circular path on the inner flange, for example as ribs. Other forms of retaining projections are also conceivable.

In the previously described exemplary embodiment of the invention, the outer sleeve is formed in one part. Alternatively, it may be expedient if the outer sleeve has a number of outer sleeve sections equal to the number of partition walls, wherein at least one outer sleeve section has an inner flange at one of its ends, and wherein adjacent outer sleeve sections can be releasably connected to one another in an air-tight manner. The connection of adjacent outer sleeve sections can be made by screw connection, by interconnected annular flanges on the outer sleeve sections, or by bayonet lock. It is also possible for the adjacent outer sleeve sections to be plugged together. The plugging together of the outer sleeve of teat cups is already part of prior art in the teat cup designs commonly encountered today.

For the teat cup of the device according to the invention, basically teat receiving tubes with any cross-sectional shape can be used. In particular, the teat-receiving tube can have a round, in particular circular, or an oval or a polygonal, in particular triangular or quadrangular cross-section, wherein the teat-receiving tube can have several sections with the same or different cross-sections in axial extension.

Finally, in the invention, a wide variety of pulsation patterns belonging to the prior art can be used per annular chamber in order to contract and relax the teat-receiving tube and to massage the teat during milking.

In particular, the device according to the invention may comprise four teat cups, the teat-receiving tubes of which are connected at their connection ends to a collecting piece of a milk discharge system comprising a housing with a collecting chamber, wherein the housing of the collecting piece has a connection for a milk discharge line of the milk discharge system and a number of pressure distributors equal to the number of annular chambers of a teat cup are arranged on the housing of the collecting piece, each pressure distributor having an input connection and four output connections, wherein the output connections of each pressure distributor are in fluid communication with different annular chambers per teat cup or per group of teat cups. The teat cups can alternatively be part of a milking equipment for manual attachment of the teat cups to the teats or alternatively be arranged on an attachment arm of a milking robot.

When using the device according to the invention, it can also be provided that the cyclic pressurization of the ring chambers of the four teat cups is carried out alternately for two pairs of teat cups or simultaneously for all four teat cups and/or by alternating negative pressure with atmospheric pressure or by alternating positive pressure with atmospheric pressure and/or by pulsation patterns controlled depending on the milk quantity. The pneumatic control of the individual ring chambers of a teat cup of the device according to the invention can be carried out by several pneumatic control units or several modules of a pneumatic control unit, each of which is assigned to a different one of the ring chambers. The pulsing with which the pneumatic control of the annular chambers is carried out is thereby possible by the modules of the pneumatic control unit or by the several control units independently of one another, wherein the control of the individual modules or of the individual pneumatic control units can be carried out in time with one another. Alternatively, however, it is also possible to realize a phase-shifted pneumatic actuation of the annular chambers of a teat cup using the conventional technique in a simple manner, in that the two or more lines connected to one and the same output of a pneumatic control unit (so-called pulsator) have different volumes due to different lengths, different cross-sections or also due to inserted chambers, so that a time delay of the effect of the pneumatic actuation on the individual annular chambers can be achieved. This can also be achieved by different volumes of the annular chambers of a teat cup. Also, the time-delayed effect of the pneumatic control of the individual ring chambers can be achieved by pneumatic relays or pneumatic time-delaying elements.

The invention is not limited to the previously described device. Rather, the invention also includes the previously described teat cup as a single component essential to the invention. In particular, the invention finally also relates to the teat-receiving tube with its different configurations according to the exemplary embodiments described above as a replacement part or as a part to be replaced of the teat cup(s) of the device according to the invention. Also, the invention is not limited to certain cross-sectional areas of teat-receiving tube and/or outer sleeve of the teat cup. Both (or respectively one) can have round and angular, in particular, for example, isosceles triangular or square or quadrangular cross-sectional surfaces.

Further variants of the device according to the invention and further embodiments thereof are the subject of the subordinate patent claims and the subclaims referring back to them.

In the following, the invention is described in more detail by means of several exemplary embodiments and with reference to the drawing, in which

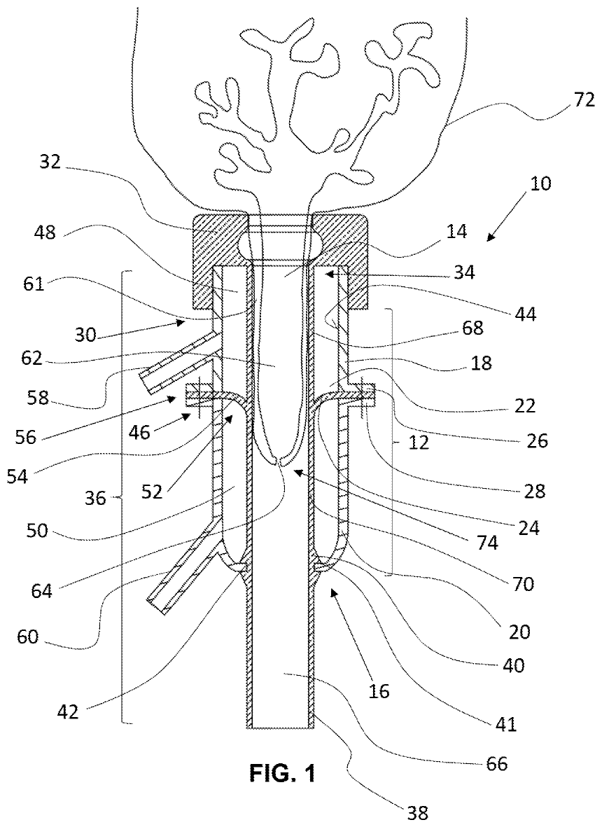

FIG. 1 is a longitudinal section through a teat cup with a teat-receiving tube according to a first exemplary embodiment of the invention,

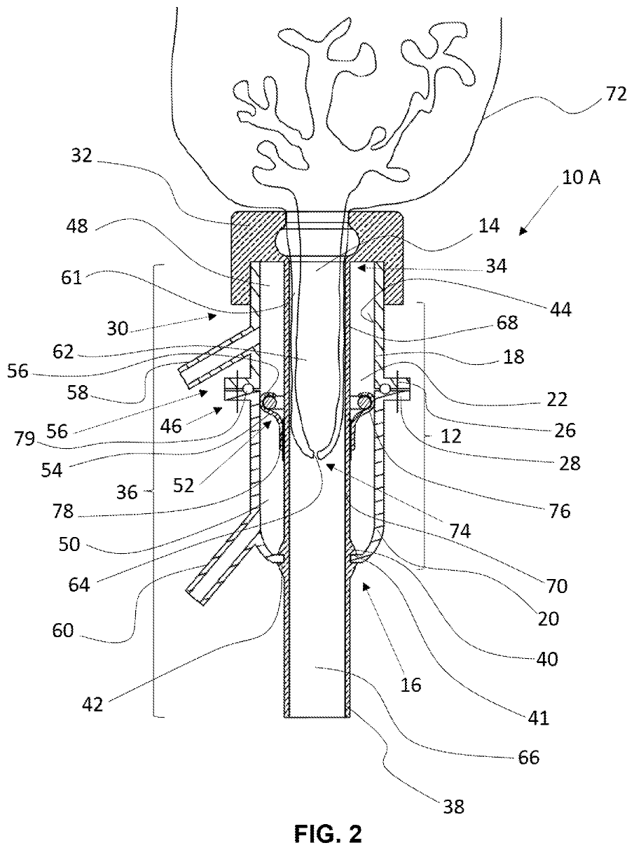

FIG. 2 is a longitudinal section through a teat cup with a teat-receiving tube according to a second exemplary embodiment of the invention,

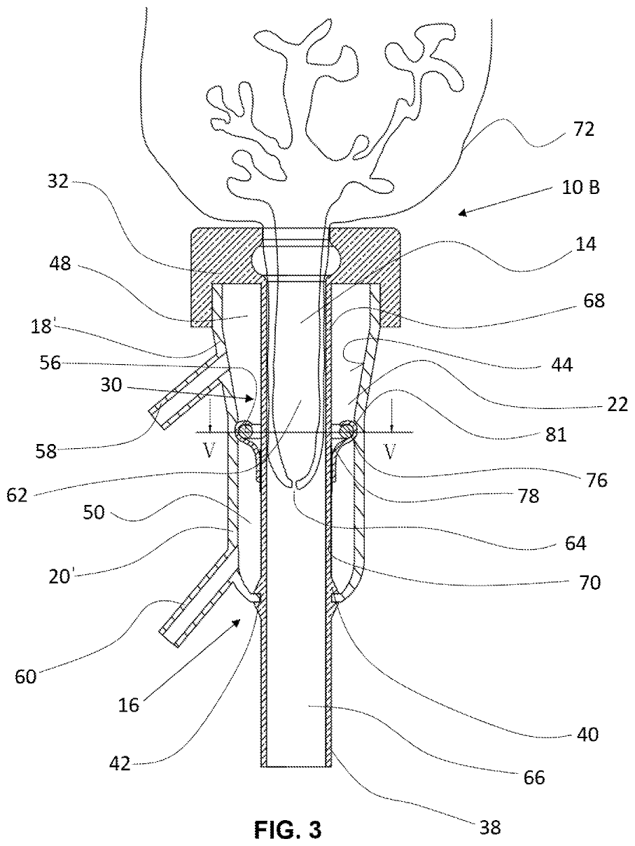

FIGS. 3 to 5 are longitudinal sections and cross-sections through a teat cup with teat-receiving tube according to a third exemplary embodiment of the invention in the pre-assembly position and end position of the teat-receiving tube,

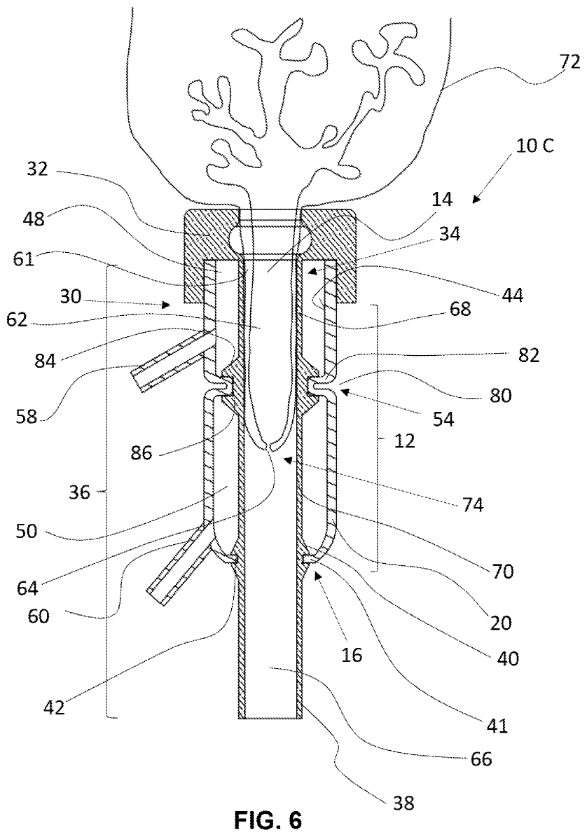

FIG. 6 is a longitudinal section through a teat cup with teat-receiving tube according to a fourth exemplary embodiment of the invention,

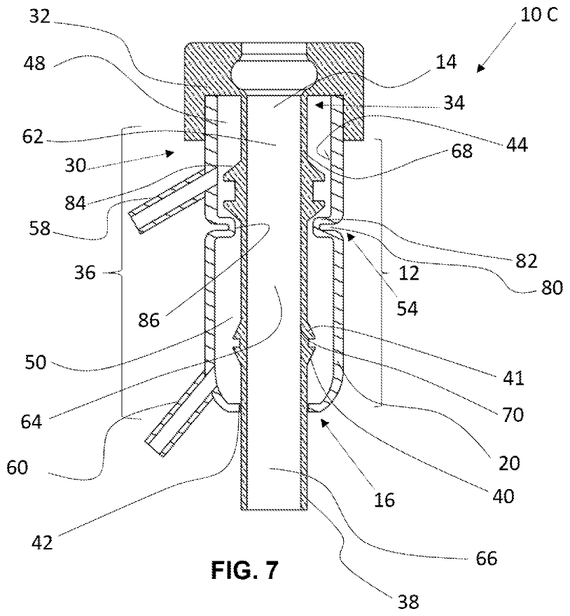

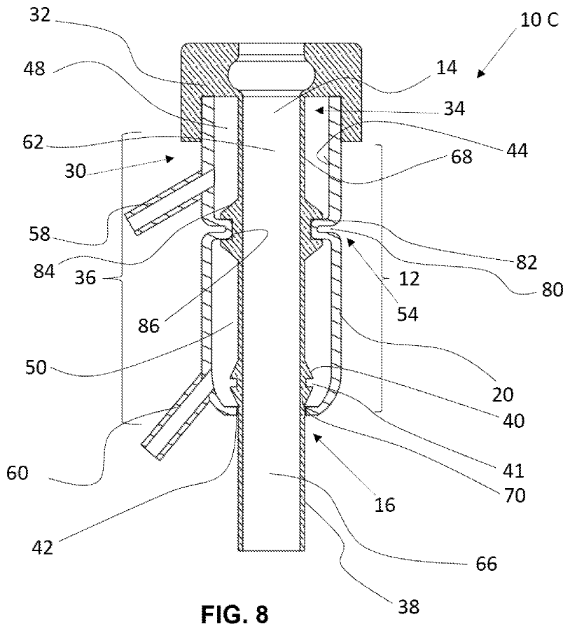

FIGS. 7 and 8 are illustrations of intermediate states upon insertion of the teat-receiving tube into the teat cup according to the fourth exemplary embodiment of FIG. 3,

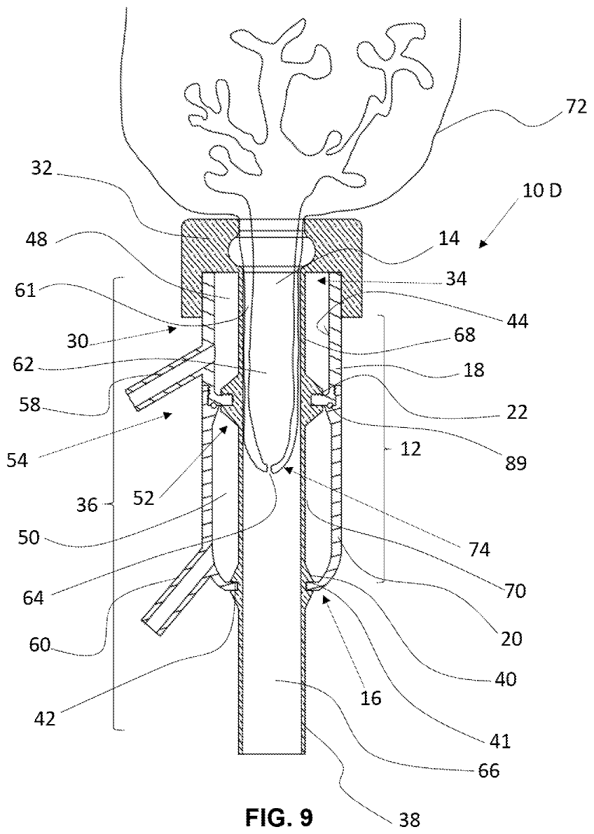

FIG. 9 is a longitudinal section through a teat cup with teat-receiving tube according to a fifth exemplary embodiment of the invention,

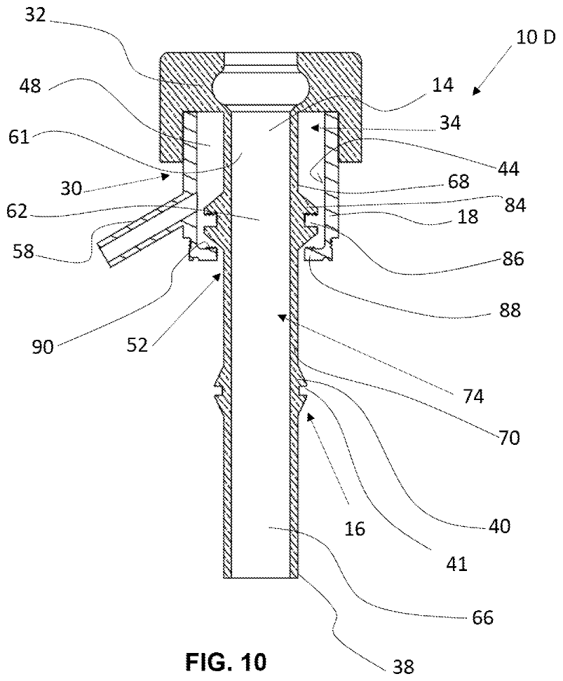

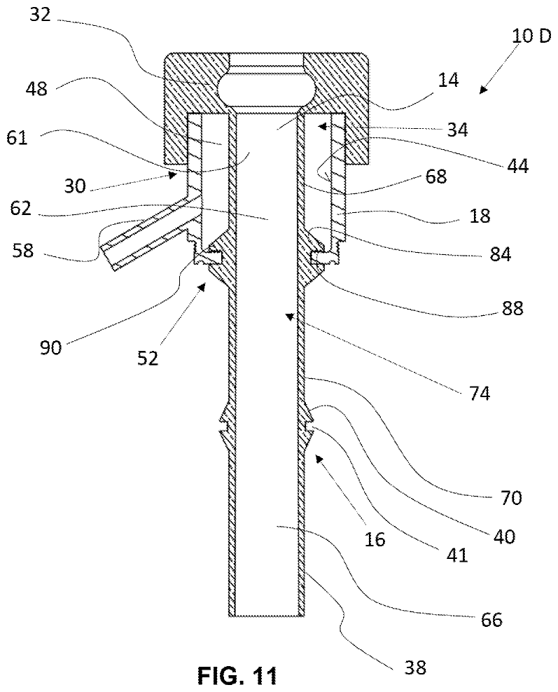

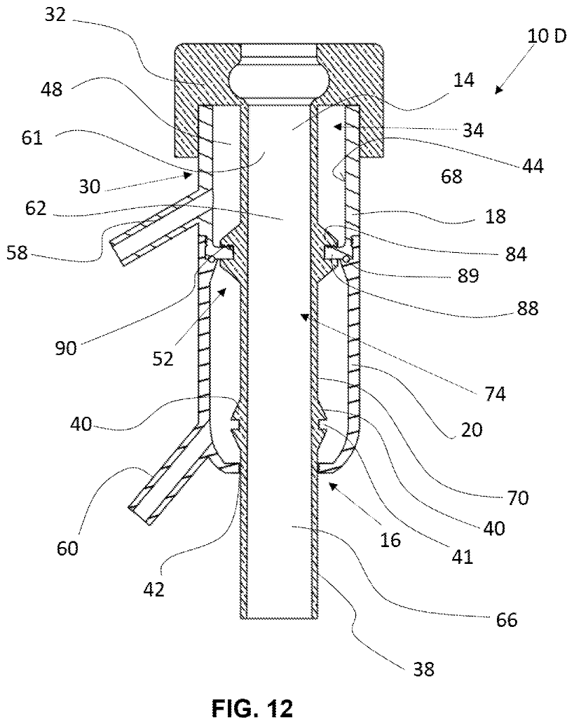

FIGS. 10 to 12 are illustrations of intermediate states upon insertion of the teat-receiving tube into the teat cup according to the fifth exemplary embodiment of FIG. 9, and

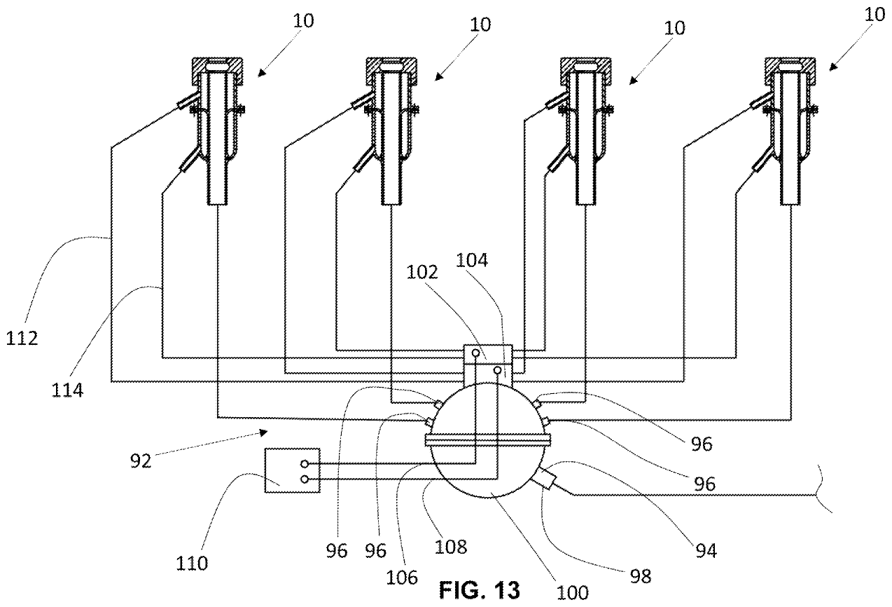

FIG. 13 is a schematic illustration of a milking equipment with four teat cups, each with an axially divided pulsation chamber, a collecting piece with pressure distributors held thereon and with a connection to the additional milk discharge system arranged thereon.

FIG. 1 shows a first exemplary embodiment of a teat cup 10 according to the invention. In this exemplary embodiment, the teat cup 10 has a two-part outer sleeve 12 made of, for example, metal or plastic, the outer sleeve 12 having an open, upper end 14 and an open, lower end 16. The outer sleeve 12 is provided with an upper outer sleeve section 18 and a lower outer sleeve section 20 which have facing axial ends 22, 24 that are each provided with an outer flange 26, 28 at which the two outer sleeve sections 18, 20 are mechanically connected to one another. The upper outer sleeve section 18 in FIG. 1 defines the upper end 14 of the outer sleeve 12, while the lower outer sleeve section 20 in FIG. 1 defines the lower end 16 of the outer sleeve 12.

A teat-receiving tube 30 is arranged within the outer sleeve 12, the teat-receiving tube 30 having a head piece 32 fitted to the upper end 14 of the outer sleeve 12 in an air-tight manner, the head piece 32 having a teat-receiving end 34 from which a tube section 36 extends through the outer sleeve 12, the tube section 36 having a connection end 38 outside the outer sleeve 12. The teat-receiving tube 30 is made of elastomeric material such as rubber. As already mentioned above, the head piece 32 seats in an air-tight manner on the upper end 14 of the outer sleeve 12. At the lower end 16 of the outer sleeve 12, the latter also sealed in an air-tight manner by the teat-receiving tube 30. This is done, for example, by means of an outer circumferential thickening 40 on the tube section 36 of the teat-receiving tube 30, said thickening 40 having an outer circumferential annular groove 41 into which the inwardly directed opening edge 42 of the lower end 16 of the outer sleeve 12 is immersed.

A peculiarity of the teat cup 10 according to FIG. 1 is that the annular space 46 formed between the teat-receiving tube 30 and the inner side 44 of the outer sleeve 12 is divided axially into an upper annular chamber 48 and a lower annular chamber 50. A partition wall 52 extends between the two annular chambers 48 and 50 and separates the two annular chambers 48, 50 from each other in an air-tight manner. In this exemplary embodiment, this partition wall 52 is configured as an annular membrane formed integrally with the tube section 36 of the teat-receiving tube 30, the outer circumferential region 56 of which is arranged in an air-tight manner between the outer flanges 26 and 28 of the two outer sleeve sections 18, 20. Both annular chambers 48, 50 are each provided with a pneumatic connecting piece 58, 60 via which the two annular chambers 48, 50 can be pressurized independently of one another (with negative or positive pressure).

By dividing the annular space 46 into the upper annular chamber 48 and the lower annular chamber 50, it is now possible to cause each annular chamber to contract independently of the other by means of pulsation patterns known per se, and thus to process different sections of a teat received by the teat-receiving tube 30 in a locally different manner in order to feed the milk out of the cistern 62 of the teat 61 via the teat canal 64. Referring to the embodiment of FIG. 1, for example, during the milking process, with negative pressure permanently applied to the interior 66 of the teat-receiving tube 30 during a processing cycle for the teat 61, the tube section 36 would first be allowed to contract in its upper section 68 extending through the upper annular chamber 48, while the lower section 70 of the tube section 36 is not contracted. With the contraction of section 68 maintained, the lower section 70 would then be allowed to contract, for example, either to relax the upper section 68 shortly thereafter, or to relax both sections 68, 70 simultaneously thereafter. With this method of treatment, a contraction beginning at the udder 72 would be successively applied to the teat 61 until it reaches the teat canal 64 or the lower end 74 of the teat 61, which would be similar to the milking process by hand.

The annular space 46 can also be divided, for example, into three axially successive annular chambers. The process described above would then be performed accordingly with respect to three differently controllable contraction sections of the teat-receiving tube within its section surrounding the teat 61.

FIG. 2 shows a first alternative exemplary embodiment of a teat cup 10A. Insofar as the individual parts or individual elements of the teat cup 10A of FIG. 2 are structurally or functionally the same as those of the teat cup 10 according to FIG. 1, they are provided in FIG. 2 with the same reference sign as in FIG. 1.

The difference between the two teat cups 10 and 10A is the way in which the partition wall 52 for dividing the annular space 46 into the upper annular chamber 48 and the lower annular chamber 50 is formed. In the exemplary embodiment according to FIG. 2, the partition wall 52 is formed as an annular membrane 54 placed around a retaining ring 76 in the form of a “skirt” 78 projecting outwardly from the teat-receiving tube 30, for example. In its outer circumferential region 56, the annular membrane 54 is placed around the outside of the retaining ring 76 and is sealingly attached thereto (e.g., by bonding) and is thus located between the retaining ring 76 and the inner side 44 of the outer sleeve 12 or the inner side 44 of the lower outer sleeve section 20. The annular membrane 54 is formed as part of a tube sleeve or skirt 78, for example, which in turn is arranged in an air-tight manner on the outside of the tube section 36 of the teat-receiving tube 30, which can be done, for example, by bonding or, in the case of elastomeric material such as rubber as the material for the skirt 78 and the teat-receiving tube 30, by vulcanization. The retaining ring 76 is also preferably bonded to the outer circumferential region 56 of the annular membrane 54. The two outer flanges 26, 28 of the outer sleeve 12 lie against each other in an air-tight manner by means of a sealing ring 79 and are mechanically connected to each other. In this exemplary embodiment, however, the outer sleeve 12 can also be designed as a single piece.

With reference to FIGS. 3 to 5, a third exemplary embodiment of a teat cup 10B is described below. Insofar as the individual parts or individual elements of the teat cup 10B of FIGS. 3 to 5 are structurally or functionally similar to those of the teat cups 10 and 10A according to FIGS. 1 and 2, they are indicated in FIGS. 3 to 5 with the same reference numerals as in FIGS. 1 and 2.

As can be seen from FIG. 3, the outer sleeve 12 is formed in one piece, with its upper outer sleeve section 18′ being tapered towards the lower second end 16. The lower second outer sleeve section 20′ is cylindrical. Within the conical outer sleeve section 18′, there is a circumferential annular receiving groove 81 on the inner side 44 of the outer sleeve 12, which serves to receive the retaining ring 76 and the outer circumferential region 56 of the annular membrane 54, which tightly encloses its outer side.

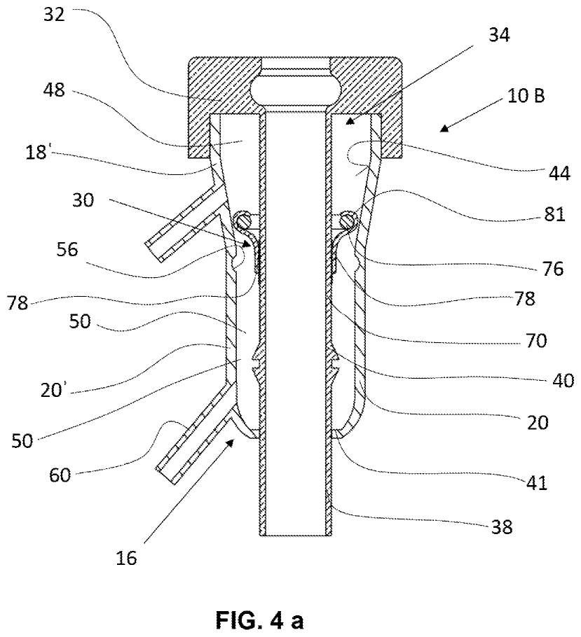

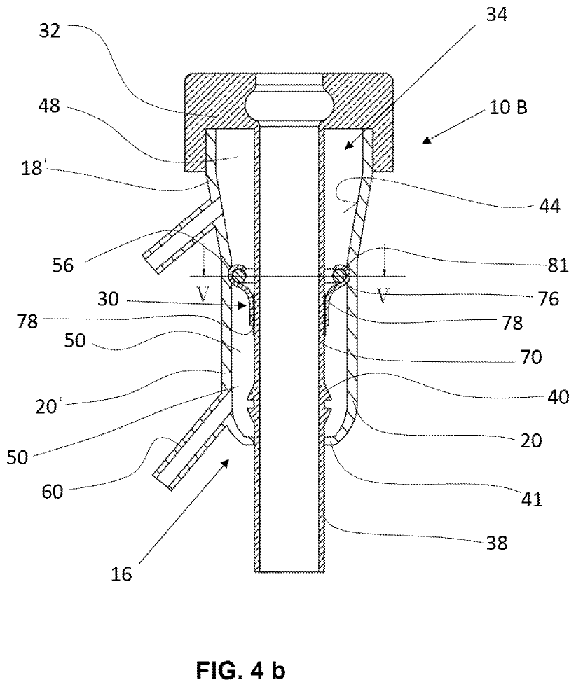

In FIG. 4a, the teat cup 10B is shown in the state of pre-assembly of the teat-receiving tube 30 in the outer sleeve 12. With its head piece 32, the t teat-receiving tube 30 sits on the first axial end 14 of the outer sleeve 12, wherein in this state the tube section 36 of the teat-receiving tube 30 extends, without being axially tensioned, through the outer sleeve 12 and protrudes with its connection end from the second axial end 16 of the outer sleeve 12. If this connection end 38 is now pulled, the retaining ring 76 slides along the conically tapering inner side 44 of the conical outer sleeve section 18′, wherein the retaining ring 76 is increasingly radially compressed. For this purpose, the retaining ring 76 is formed as a spring ring 77, which will be described further below. Finally, the retaining ring 76 reaches the level of the receiving groove 81 and engages therein due to its radially outwardly acting pretensioning force (see FIG. 4b). The outer circumferential region 56 of the annular membrane 54 is now held clamped between the receiving groove 81 and the outwardly biased retaining ring 76, thus sealingly separating the upper annular chamber 48 from the lower annular chamber 50. By further pulling on the connection end 38 of the teat-receiving tube 30, the latter engages as known at the second axial end 16 of the outer sleeve 12, whereby the teat-receiving tube 30 is then held overall under axial tension in the outer sleeve 12 (see FIG. 3).

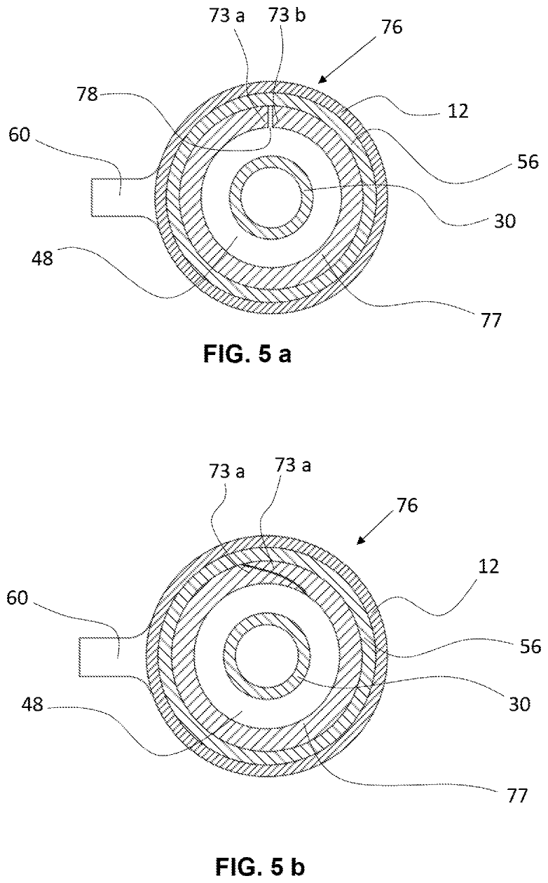

FIGS. 5a and 5b show two exemplary embodiments of the retaining ring 76 formed as a spring ring 77. These are cross-sectional views along the line V-V of FIG. 4. According to FIG. 5a, the spring ring 77 is slotted with a distance 75 between its two ends 73a and 73b. In the exemplary embodiment according to FIG. 5b, the slit of the spring ring 77 does not run radially, but at an acute angle thereto, so that the two ends 73a, 73b of the spring ring 77 overlap. In both cases, the design of the spring ring 77 permits its radial compression, which results in the then radially outwardly acting pretensioning force of the spring ring 77, which in this respect can also be called a snap ring.

In FIG. 6, a further exemplary embodiment of a teat cup 10C is described. Here too, insofar as the individual parts or individual elements of the teat cup 10C of FIG. 6 are structurally or functionally similar to those of the teat cup 10 according to FIG. 1, they are provided in FIG. 6 with the same reference numerals as in FIG. 1.

The main difference of the construction of the teat cup 10C compared to those of the teat cups 10, 10A and 10B of FIGS. 1 to 5 is that the teat cup 10C according to FIG. 3 has a different construction of the partition wall 52. In this exemplary embodiment, the outer sleeve 12 is formed in one piece and is formed of metal, for example. An inner flange 82 is formed on the inner side 44 of the outer sleeve 12 by a curling, i.e., circumferential constriction 80, which is formed in an air-tight manner from an outer circumferential thickening 84 in the tube section 36 of the teat-receiving tube 30. This outer circumferential thickening 84 has a circumferential receiving groove 86 that surrounds the inner flange 82 internally and forms an air-tight seal.

FIGS. 4 and 5 show two phases of inserting the teat-receiving tube 30 into the outer sleeve 12 according to FIG. 4. First, the teat-receiving tube 30 is placed with its head piece 32 onto the upper end 14 of the outer sleeve 12. The tube section 36, which is now loose, i.e. without the axial tension typically found in teat cups, is now axially tensioned in the teat cup 10C so that the outer circumferential thickening 84 “locks” with the inner flange 82. This results in the situation according to FIG. 5. If the teat-receiving tube 30 is now further axially tensioned, the outer circumferential thickening 40 and the opening edge 42 at the lower end 16 of the outer sleeve 12 engage with each other in a sealing manner, resulting in the installation situation according to FIG. 3.

The advantage of the embodiment of the teat cup 10C is that the air-tight closures of the two annular chambers 48 and 50 as well as at the lower end 16 of the outer sleeve 12 are produced automatically in a simple manner by merely axially tensioning the teat-receiving tube 30.

In this respect, an equally advantageous configuration of a teat cup 10D is shown in FIG. 6. Again, in FIG. 6, those elements of the teat cup 10D which have the same function or the same design as the individual components of the teat cups of the previously described embodiments are provided with the same reference numerals as in FIGS. 1 to 8.

The difference of the teat cup 10D compared to the previously described exemplary embodiments of the teat cups can be seen in the design of the partition wall 52. In the exemplary embodiment according to FIG. 6, the partition wall 52 is implemented by an inner flange 88 on the upper outer sleeve section 18. The upper outer sleeve section 18 can be bolted to the lower outer sleeve section 20. Again, as in the exemplary embodiment of FIG. 3, the teat-receiving tube 30 has an outer circumferential thickening 84 that is in air-tight engagement with the inner flange 88. The two outer sleeve sections 18, 20 are joined together in an air-tight manner by means of a sealing ring 89 when they are screwed together.

The assembly of the teat cup 10D is shown step by step in FIGS. 7 to 10. According to FIG. 7, first the head piece 32 of the teat-receiving tube 30 is placed on the upper end 14 of the upper outer sleeve section 18. At this point, the lower outer sleeve section 20 can be unscrewed. When the tube section 36 is now pulled, the outer circumferential thickening 84 and its groove 86 engage with the inner flange 88 in an air-tight manner, as shown in FIG. 8. The inner flange 88 expediently has a corrugation or similar retaining protrusions 90 on both its upper and lower sides, or on one of these two sides. The corrugation or retaining projections 90 mechanically engage the inner flange 88 with the outer circumferential thickener 84 and hold it in position, whereby slippage of the outer circumferential thickening 84 from the inner flange 88 can be safely prevented.

Starting from the situation according to FIG. 8, the lower outer sleeve section 20 is now screwed on, as shown in FIG. 9. In this situation, the outer circumferential thickening 40 is still located above the lower end 16 of the outer sleeve section 20. If the tube section 36 of the teat-receiving tube 30 is now pulled axially, the outer circumferential thickening 40 engages with the opening edge 42 of the outer sleeve section 20. This then results in the situation according to FIG. 6.

FIG. 10 schematically shows a milking equipment 92 with four teat cups 10 according to the invention, which in this example are each designed as described above with reference to FIG. 1. The milking equipment also includes a milk collecting piece 94 having four connections 96 for the connection ends 38 of the four teat cups 10. The collecting piece 94 has an outlet connection 98 which is in fluid communication with the milk collection system (not shown) and is subjected to negative pressure via the corresponding line system. This negative pressure is applied to the connection ends 38 of the teat-receiving tubes 30 of the teat cups 10 by means of the collecting piece 94.

Two pressure distributors 102, 104 are arranged on the housing 100 of the collecting piece 94. A separate pneumatic line 106, 108 leads to each pressure distributor 102, 104, and pressure pulsation patterns can be applied to said lines separately via a control valve device 110. The pressure present in each of the lines 106 and 108, respectively, is then applied accordingly to the lower annular chambers 50 and the upper annular chambers 48 of the teat cups 10. The two pneumatic lines 106, 108 may be formed in one piece as a double hose line, thereby reducing the number of individual tubes leading to the collecting piece 94. Likewise, it is possible for the two pneumatic lines 112, 114, each leading to a teat cup 10, to be designed as a double hose line, each of which is “fanned out” at its ends in order to be connected, on the one hand, to the pressure distributors 102, 104 and, on the other hand, to the connecting pieces 58, 60 of the teat cups 10.

### LIST OF REFERENCE NUMERALS

10 teat cup

10A teat cup

10C teat cup

10D teat cup

12 outer sleeve

14 first axial end of outer sleeve

16 second axial end of outer sleeve

18 outer sleeve section

18′ upper conical outer sleeve section

20 outer sleeve section

20′ lower cylindric outer sleeve section

22 axial end of outer sleeve section 18

24 axial end of outer sleeve section 20

26 outer flange

28 outer flange

30 teat-receiving tube

32 head piece of teat-receiving tube

34 teat-receiving end

36 tube section of teat-receiving tube

38 connection end of teat-receiving tube

40 outer circumferential thickening

41 outer circumferential annular groove

42 opening edge

44 inner side of outer sleeve

46 annular space

48 annular chamber

50 annular chamber

52 partition wall between annular chambers

54 annular membrane

56 outer circumferential region

58 pneumatic connecting pieces

60 pneumatic connecting pieces

61 teat

62 cistern

64 teat canal

66 inside of teat-receiving tube

68 section of teat-receiving tube

70 section of teat-receiving tube

72 udder

73a end of spring ring

73b end of spring ring

74 end of teat

76 retaining ring

77 spring ring

78 skirt

79 sealing ring

80 constriction

87 receiving groove

82 inner flange

84 outer circumferential thickening

86 circumferential receiving groove

88 inner flange

89 sealing ring

90 retaining projection

92 milking equipment

94 milk collection piece

96 connections at milk collecting piece

98 outlet connection of milk collecting piece

100 housing of milk collecting piece

102 pressure distributor

104 pressure distributor

106 pneumatic line

108 pneumatic line

110 control valve device

112 pneumatic line

114 pneumatic line

1. A device for milking animals, comprising
at least one teat cup having a rigid outer sleeve and an elastic teat-receiving tube being arranged in the outer sleeve,
wherein the outer sleeve comprises an open first end and an open second end opposite thereto,
wherein the teat-receiving tube has a teat-receiving end abutting the first end of said outer sleeve in an air-tight manner and a connection end projecting beyond the second end of the outer sleeve for connection to a milk discharge system and abutting the second end of the outer sleeve in an air-tight manner,
wherein the teat-receiving tube is surrounded by an annular space and extends under axial tension within the outer sleeve between the two ends thereof,
wherein the annular space is divided in axial extension into at least two or three annular chambers which are separated from each other in an air-tight manner by a partition wall,
wherein each annular chamber is in fluid communication with a pneumatic line via which the respective annular chamber can be selectively and independently of the respective adjacent annular chamber subjected to negative and/or positive pressure and atmospheric pressure in accordance with a predeterminable time-dependent pulsation pattern, and
a pneumatic control unit for exerting a negative pressure in the teat-receiving tube with simultaneous cyclic pressurization of the annular chambers by alternately applying negative and/or positive pressure and atmospheric pressure in accordance with a predeterminable time-dependent pulsation pattern,
wherein the at least one partition wall is formed as an elastomeric annular membrane extending from the teat-receiving tube and having an outer circumferential region facing away from the teat-receiving tube, with which the annular membrane abuts in its outer circumferential region against the inner side of the outer sleeve and is held sealingly against the inner side of the outer sleeve by a retaining ring which is tightly surrounded radially outwardly by the outer circumferential region of the annular membrane,
wherein the retaining ring is formed as a radially outwardly biased spring ring the diameter of which can be reduced by generating an outwardly directed biasing force, and
wherein a circumferential receiving groove is formed on the inner side of the outer sleeve for receiving the spring ring in its region enclosed by the outer circumferential region of the annular membrane.

2. The device according to claim 1, wherein the outer sleeve is cylindrical or has a partial section tapering towards the second end of the outer sleeve, in which the receiving groove is formed.

3. The device according to claim 1, wherein the spring ring is slotted and has two ends facing each other which, in the relaxed state of the spring ring, have are spaced apart from one another, or that the spring ring is slotted and has two ends facing each other which overlap in the relaxed state of the spring ring.

4. The device according to claim 3, wherein the two ends of the spring ring are radially or axially adjacent to each other or radially or axially offset from each other.

5. A device for milking animals, comprising
at least one teat cup having a rigid outer sleeve and an elastic teat-receiving tube being arranged in the outer sleeve,
wherein the outer sleeve comprises an open first end and an open second end opposite thereto,
wherein the teat-receiving tube has a teat-receiving end abutting the first end of said outer sleeve in an air-tight manner and a connection end projecting beyond the second end of the outer sleeve for connection to a milk discharge system and abutting the second end of the outer sleeve in an air-tight manner,
wherein the teat-receiving tube is surrounded by an annular space and extends under axial tension within the outer sleeve between the two ends thereof,
wherein the annular space is divided in axial extension into at least two or three annular chambers which are separated from each other in an air-tight manner by a partition
wherein each annular chamber is in fluid communication with a pneumatic line via which the respective annular chamber can be selectively and independently of the respective adjacent annular chamber subjected to negative and/or positive pressure and atmospheric pressure in accordance with a predeterminable time-dependent pulsation pattern, and
a pneumatic control unit for exerting a negative pressure in the teat-receiving tube with simultaneous cyclic pressurization of the annular chambers by alternately applying negative and/or positive pressure and atmospheric pressure in accordance with a predeterminable time-dependent pulsation pattern,
wherein the outer sleeve is cylindric and has a partial section tapering towards the second end of the outer sleeve, and
wherein the outer sleeve has a number of axially successive outer sleeve sections equal to the number of ring membranes, and wherein the outer circumferential region of the at least one ring membrane is arranged in an air-tight manner between the mutually facing ends of two adjacent outer sleeve sections.

6. The device according to claim 5, two adjacent outer sleeve sections are screwed together in an air-tight releasable manner and/or are connected to each other in a releasable manner by individual connecting elements, such as screws or screws with screw nuts or by a bayonet lock, and/or are inserted into each other in an air-tight releasable manner.

7. The device according to claim 5, wherein the at least one annular membrane is integrally formed with the teat-receiving tube or is bonded thereto in an air-tight manner by bonding.

8. The device for milking animals, comprising
at least one teat cup having a rigid outer sleeve and an elastic teat-receiving tube being arranged in the outer sleeve
wherein the outer sleeve comprises an open first end and an open second end opposite thereto,
wherein the teat-receiving tube has a teat-receiving end abutting the first end of said outer sleeve in an air-tight manner and a connection end projecting beyond the second end of the outer sleeve for connection to a milk discharge system and abutting the second end of the outer sleeve in an air-tight manner,
wherein the teat-receiving tube is surrounded by an annular space and extends under axial tension within the outer sleeve between the two ends thereof,
wherein the annular space is divided in axial extension into at least two or three annular chambers which are separated from each other in an air-tight manner by a partition
wherein each annular chamber is in fluid communication with a pneumatic line via which the respective annular chamber can be selectively and independently of the respective adjacent annular chamber subjected to negative and/or positive pressure and atmospheric pressure in accordance with a predeterminable time-dependent pulsation pattern, and
a pneumatic control unit for exerting a negative pressure in the teat-receiving tube with simultaneous cyclic pressurization of the annular chambers by alternately applying negative and/or positive pressure and atmospheric pressure in accordance with a predeterminable time-dependent pulsation pattern,
wherein the at least one partition wall is designed as an inner flange projecting from the inner side of the outer sleeve into the annular space and having an inner circumferential edge, and wherein the teat-receiving tube is provided with at least one outer circumferential groove, in which the inner circumferential edge of the inner flange is received in an air-tight manner, or is provided with at least one outer circumferential rib which is received in an air-tight manner in a groove on the inner circumferential edge of the inner flange.

9. The device according to claim 8, wherein at least one retaining projection and preferably several retaining projections arranged distributed along the inner circumferential edge of the inner flange protrude in axial extension of the outer sleeve, wherein the projection or projections, in order to ensure the air-tight contact of the teat-receiving tube with the inner circumferential edge of the inner flange, engages or engage with the teat-receiving tube in the event of contraction of the teat-receiving tube.

10. The device according to claim 8, wherein the outer sleeve has a number of outer sleeve sections equal to the number of partition wherein at least one outer sleeve section has an inner flange at one of its ends, and wherein adjacent outer sleeve sections can be releasably connected to one another in an air-tight manner.

11. The device according to claim 8, wherein the teat-receiving tube has a round, in particular circular, or an oval or a polygonal, in particular triangular or quadrangular cross-section, wherein the teat-receiving tube can have several sections with the same or different cross-sections in axial extension.

12. The device according to claim 8, comprising four teat cups, the teat-receiving tubes of which are connected at their connection ends to a collecting piece of a milk discharge system comprising a housing with a collecting chamber, wherein the housing of the collecting piece has a connection for a milk discharge line of the milk discharge system and a number of pressure distributors equal to the number of annular chambers of a teat cup are arranged on the housing of the collecting piece, each pressure distributor having an input connection and four output connections, wherein the output connections of each pressure distributor are in fluid communication with different annular chambers per teat cup or per group of teat cups.

13. The device according to claim 12, wherein the cyclic pressurization of the ring chambers of the four teat cups is carried out alternately for two pairs of teat cups or simultaneously for all four teat cups and/or by alternating negative pressure with atmospheric pressure or by alternating positive pressure with atmospheric pressure and/or by pulsation patterns controlled depending on the milk quantity.

14. The device according to claim 8, configured to milk cows.
